(19) United States
(12) Patent Application Publication
(10) Pub. No.: US 2026/0359842 A1
(43) Pub. Date: Nov. 12, 2026

(54) RIDESHARING LIFECYCLE RISK MANAGEMENT

(71) Applicant: GRABTAXI HOLDINGS PTE. LTD., Singapore (SG)

(72) Inventors: Benjamin Hong Hua CHOO, Petaling Jaya (MY); Naureen AZEEZ, Bengaluru (IN); Joshua Mun Wei CHAN, Petaling Jaya (MY); Shuya DING, Singapore (SG); Haitao BAO, Singapore (SG); Amanda Mariko SAKAI, Petaling Jaya (MY)

(21) Appl. No.: 19/117,207

(22) PCT Filed: Sep. 14, 2023
(86) PCT No.: PCT/SG2023/050624

§ 371 Date: Mar. 31, 2025

(30) Foreign Application Priority Data
Oct. 4, 2022 (SG) 10202251264T

(51) Int. Cl. G06Q 30/018; G06Q 50/43

(52) U.S. Cl. CPC G06Q 30/0185; G06Q 50/43

(57) ABSTRACT

Systems and methods for ridesharing risk management by determining a passenger risk score based on passenger's records in the database; determining a driver risk score for each driver in a set of candidate drivers. Determining a pre-ride risk score for each driver based on the driver risk score, the passenger risk score and one or more ride request conditions. Designating a driver from the set of candidate drivers with a pre-ride risk score below a first predefined threshold. Periodically receiving signals from the passenger's computing device or the designated driver's computing device on commencement of the ride and evaluating an in-transit risk score associated with ride based on conformity of the received signals with an expected ride plan.

### TECHNICAL FIELD

This disclosure generally relates to methods and systems for lifecycle risk management for ridesharing service platforms.

### BACKGROUND

This background is provided for the purpose of generally presenting the context of the disclosure. Contents of this background section are neither expressly nor impliedly admitted as prior art against the present disclosure.

With the growth in ridesharing services, platforms enabling the ridesharing services have amassed a significant volume of data relating to drivers, passengers and rides undertaken by passengers. The volume of data relating to rides continues to grow exponentially with increasing reach of such services. The data may include data relating to the biographical details of the users of the rideshare system for security and authentication purposes. Data relating to riders (passengers) may include data of an origin, destination, time and review data relating to the ride. Ridesharing platforms may also have access to publically available data relating to individuals that are users of the rideshare service. The data amassed by the ridesharing platforms presents an opportunity to improve the experiences of passengers and drivers and proactively manage risks that may arise in the provision of the rideshare service. The risks may include risks to the safety of the passengers or drivers. The risks also include risks of accidents or undesirable events during a rise or a prospective ride.

It is desired to address or ameliorate one or more disadvantages or limitations associated with the conventional systems and methods for ridesharing risk management, or to at least provide a useful alternative.

### SUMMARY

The disclosure provides a system for ridesharing risk management, the system comprising: one or more processors (processor(s)); a memory accessible to the processor(s); a database comprising a plurality of passenger and driver records accessible to the processor(s); the memory comprising program code executable by the processor(s) to: receive a request for a ride from a passenger's computing device; determine a passenger risk score based on passenger's records in the database; determine a driver risk score for each driver in a set of candidate drivers for the ride based on each driver's records in the database; determine a pre-ride risk score for the ride for each driver based on the driver risk score for the respective driver, the passenger risk score and one or more ride request conditions; designate a driver from the set of candidate drivers with a pre-ride risk score below a first predefined threshold; periodically receive signals from the passenger's computing device or the designated driver's computing device on commencement of a ride; evaluate an in-transit risk score associated with the ride based on conformity of the received signals with an expected ride plan; and on the in-transit risk score exceeding a second predefined threshold, trigger a ride incident event.

The disclosure also provides a system for ridesharing risk management, the system comprising: one or more processors (processor(s)); a memory accessible to the processor(s); a database comprising a plurality of passenger and driver records accessible to the processors(s); the memory comprising program code executable by the processor(s) to: receive a request for a ride from a passenger's computing device; determine a pre-ride risk score for the ride for each driver based on the plurality of passenger and driver records, and one or more ride request conditions; designate a driver from the set of candidate drivers with a pre-ride risk score below a first predefined threshold; periodically receive signals from the computing device of the passenger or the designated driver on commencement of the ride; evaluate an in-transit risk score associated with ride based on conformity of the received signals with an expected ride plan.

The disclosure also provides a computer-implemented method for ridesharing risk management, the method comprising: receiving a request for a ride from a passenger's computing device; determining a passenger risk score based on passenger's records in a database; determine a driver risk score for each driver in a set of candidate drivers for the ride based on each driver's records in the database; determining a pre-ride risk score the ride for each driver based on the driver risk score, the passenger risk score and one or more ride request conditions; designating a driver from the set of candidate drivers with a pre-ride risk score below a first predefined threshold; periodically receiving signals from the computing device of the passenger or the designated driver on commencement of the ride; evaluating an in-transit risk score associated with ride based on conformity of the received signals with an expected ride plan; on the in-transit risk score exceeding a second predefined threshold, triggering a potential ride incident event.

The disclosure also provides a computer-implemented method for ridesharing risk management, the method comprising: receiving a request for a ride from a passenger's computing device; determining a pre-ride risk score the ride for each driver in a set of candidate drivers, based on a plurality of passenger and driver records, and one or more ride request conditions; designating a driver from the set of candidate drivers with a pre-ride risk score below a first predefined threshold; periodically receiving signals from the computing device of the passenger or the designated driver on commencement of the ride; evaluating an in-transit risk score associated with ride based on conformity of the received signals with an expected ride plan.

### BRIEF DESCRIPTION OF THE DRAWINGS

Exemplary embodiments of the present invention are illustrated by way of example in the accompanying drawings in which like reference numbers indicate the same or similar elements and in which:

FIG. 1 illustrates a block diagram of a system for ridesharing lifecycle risk management and its associated components;

FIG. 2 illustrates a flowchart for a method for ridesharing lifecycle risk management; and

FIGS. 3 and 4 illustrate a schematic diagram of designation of a driver to a passenger incorporating the disclosed methods and risk management.

### DETAILED DESCRIPTION

With the rise in popularity of e-hailing services today, one challenge is ensuring the safety of both passengers and drivers, identifying incidents that may have occurred and providing the data and alerting infrastructure to respond to any safety related incidents expeditiously. Safety related incidents are driving related incidents such as accidents, drunk driving, harassment related incidents such as harassment in person or through phone/text, crime related incidents such as physical or sexual assault, theft etc.

A typical lifecycle of a ride through a ridesharing service comprises a customer requesting a ride through their smartphone. A driver is assigned to the customer and the ride commences on the driver picking up the passenger. The ride concludes when a passenger is dropped off. Between the request for a ride and the drop off, there can be several computer systems that communicate with each other to facilitate the ride and generate meaningful data that is leveraged by the disclosed systems and method that use this data to perform risk management or generate alerts regarding potential incidents. In conventional systems, in the event of a safety incident during a ride, assistance may be provided only if the incident is reported by the passenger, the driver or a 3^{rd} party.

The disclosed systems and methods improve the ridesharing experience and safety in every phase of the lifecycle. The disclosed systems and methods also process data (both historical and real-time data) to predict the risk of an incident occurring and guide decision making regarding allocation of drivers to mitigate such risks.

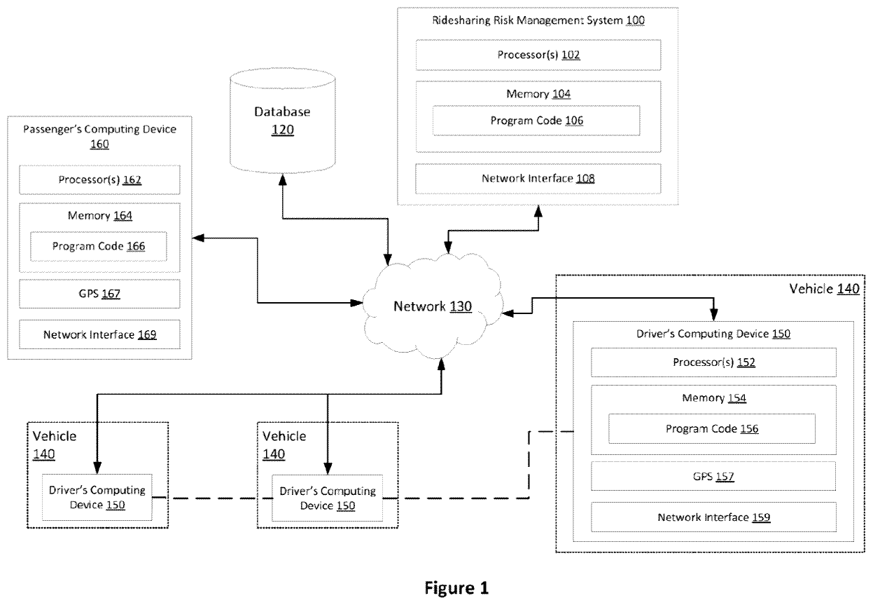

FIG. 1 illustrates a block diagram of a system for ridesharing risk management and its associated components. A ridesharing risk management system 100 comprises at least one processor 102, memory 104 accessible to the processor 102 and a network interface 108 to facilitate communication with a plurality of driver's computing devices 150 and a user's computing device 160. Program code 106 provided in memory 104 comprises instructions executable by the processor 102 to perform at least a part of the method of the embodiments described herein. Notably, while individual computer systems are described in FIG. 1, any such computer system may be distributed across multiple servers or multiple devices, or some functionality may be consolidated into a single server or device, without departing from the purposive intent of the present disclosure.

The driver's computing device 150 is associated with a specific vehicle 140 driven by the respective driver. The driver's computing device 150 comprises at least one processor 150, a memory 154, a GPS device 157 and a network interface 159. The memory 154 comprises program code 156 comprising instructions executable by the processor 152 to facilitate interactions with the rideshare risk management system 100. The user's computing device 160 comprises one or more processors 162, a memory 164, a GPS device and a network interface 169. The memory 164 comprises program code 166 comprising instructions executable by the processor 162 to facilitate interactions with the rideshare risk management system 100. The driver's computing device and the user's computing device may include a personal or handheld computing device such as a smartphone or a tablet. Network 130 facilitates communication between the various devices and may include one or more communication networks including the internet, cell phone networks etc.

One or more database 120 are also accessible to the system 100. The database 120 may comprise historical data relating to rides taken by passengers or rides provided by drivers and associated information. The historical data relating to the rides may include time, date of the ride, origin, destination of the ride, review data, feedback or comments by passengers and drivers provided in relation to a ride. The database 120 may also include biographical details relating to passengers and drivers including information collected during identity verification of the passengers or drivers, payment related details etc. The database 120 may also comprise historical data relating to past incidents that a passenger or driver may have been involved in. In some embodiments, database 120 may also include 3rd party databases comprising identity records or crime/irregularity notifications records.

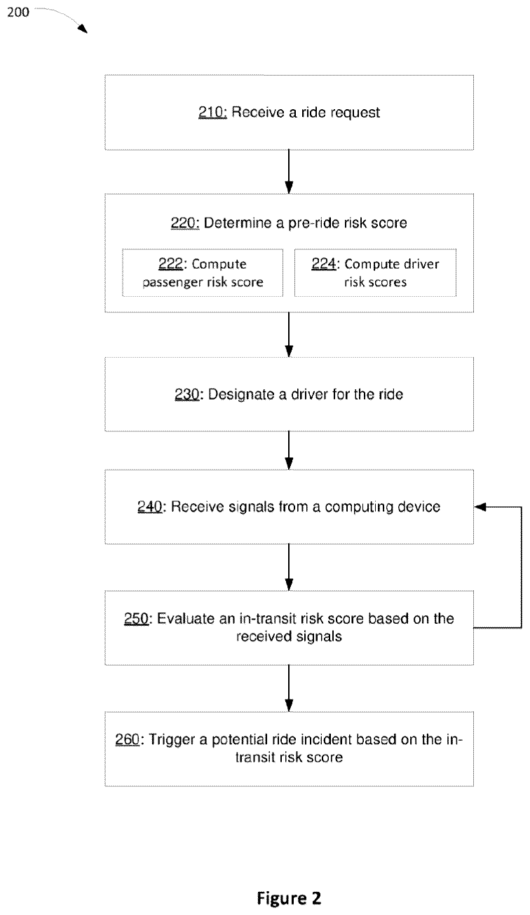

The risk management system considers risks during one or more phases of a rideshare lifecycle to improve outcomes over the entirety of the experience of a passenger and driver. FIG. 2 illustrates a flowchart of a method 200 of ridesharing lifecycle risk management executable by the system 100. A first phase of risk management relates to a pre-ride phase which is implemented by steps 210, 220 and 230. One objective of the pre-ride phase is to support the allocation of drivers to passengers such that the risk of an incident during the subsequent ride—i.e. the ride resulting from the request for a ride made by the passenger—is lowered. Depending on the characteristics of passengers and drivers derived from the data relating to them, the method identifies matches between passengers and drivers that may potentially reduce the likelihood of incidents.

At step 210, the system 100 receives a request for a ride from the passenger's device 160. The request may be conveyed through other components of a ridesharing system or platform. The request comprises origin, destination information, time of ride and identity of one or more passengers requesting the ride. In other embodiments, greater or fewer data points (i.e. destination information, time of ride etc) may be captured depending on the data used in the risk assessment process.

At step 220, the system 100 determines a pre-ride risk score associated with the pairing of the passenger with each driver in an available pool of candidate drivers. The candidate pool of drivers may be determined based on drivers that are available (i.e. not currently undertaking a ride), are near their drop-off point—e.g. within 5 mins of dropping off the current passenger—have a drop-off point near the passenger who made the request for the ride, are within a predetermined distance or time from the origin—e.g. 5 km or 10 mins—and so on. The pre-ride risk score serves as a quantitative indicator of the risk associated with a particular pairing of a passenger and a driver. As part of step 220, a passenger risk score is computed at step 222 using historical information relating to the passenger to assign a risk score to the customer. The historical information relating to the passenger is retrieved from the database. A passenger with a risk score higher than a threshold may be flagged by the system 100 as a passenger requiring greater degree of risk management depending on the nature of the flagged risk.

The passenger risk score is determined based on a plurality of risk indicators generated based on the passenger's records accessible to the system 100. The risk indicators are each a numerical representation of the various dimensions of risk related data available to the system 100. The risk indicator may include: passenger biographical record accuracy indicator, passenger biographical record freshness indicator, passenger interaction review indicator, or passenger historical incident indicator.

The passenger biographical record accuracy indicator is a measure of the accuracy or completeness of the passenger's biographical record with the ridesharing service. The accuracy or completeness may be evaluated on comparison of the records with 3rd party sources of biographical information, such as identity verification service providers etc. The time of last update of the passenger biographical record may contribute to the passenger biographical record freshness indicator. For example, a biographical record without any recent updates may by assigned a lower freshness score which would amount to a higher risk score. A passenger with a more recently updated photograph may be assigned a higher freshness score which would amount to a lower risk score.

Passenger interaction review indicator relates to reviews the passenger may have received from drivers over their past use of the ridesharing service. Low or poor reviews serve as an indicator of higher risk. While high or good reviews serve as indicators of lower risk. Passenger incident indicator relates to records of any incidents that passenger may have previously been involved in or records of criminal behavior or negative behavior from internal sources. Internal sources may include incidents on record with the company offering the service. For example, internal sources may include a program or algorithm model capable of tracking text from comments or ratings on the platform that are of an abusive or harassment-related nature. The number or frequency of cancellations by a passenger may contribute to the passenger risk score.

Each of the indicators are represented in a numerical form, with their respective values indicating a degree of potential risk associated with the passenger. For example, the accuracy of biographical information may be represented by a number indicative of the extent to which the passenger's self-declared biographical matches a 3rd party source of truth of the biographical information. Similarly, the number of days since the last selfie provided by the passenger may be accounted for by the passenger biographical record freshness indicator. Each of the indicators may be assigned a specific weight reflecting the degree to which they meaningfully represent the degree of risk associated with a passenger.

Log standardization may be applied to the sum of the indicator values to transform the overall passenger risk value into a value in a predefined range. The predefined range may be the range of values 1 to 10. A passenger risk score may be calculated as:

$$PAX Risk Score = \frac{Ln ( Sum of indicator values )}{Ln ( maximum historical risk score )} * 10$$

As part of step 222 if a person's risk score is determined to be above an acceptable threshold, then the passenger may be prompted to provide further information or verify their identify before continuing with their request for the ride.

Step 224 comprises the determination of driver risk scores for all or a subset of candidate drivers in the vicinity of the passenger. The subset may be determined by reference to any indicator or parameter such as top 20 drivers closest to the origin, or by matching only female drivers with female passengers who have requested matching with only female drivers. Similar to the calculation of the passenger risk score, the driver risk scores are based on a plurality of measurable indicators relating to the driver. The indicators include: driver biographical record accuracy indicator, driver biographical record freshness indicator, driver interaction review indicator, driver incident indicator. The indicators relating to the driver may be calculated in the same manner as the indicators relating to the passenger. The measurable indicators relating to the driver may be retrieved from the database.

The driver incident indicator may additionally account for the driver's conformity to traffic rules and safe driving expectations or standards. The driver incident indicator may take into account data from 3rd party databases such as traffic violations databases to extract data relating to traffic violations by drivers. As an example, the driver risk score of a driver may be higher for drivers with a greater number of traffic violation records.

The passenger and driver risk scores may be precomputed and accessible to the system 100 for computational efficiency. The passenger and driver risk scores may be computed using a supervised machine learning model that receives as inputs raw data relating to the various risk indicators and generates the risk scores as an output. The supervised learning model may be trained using historical incident data and may serve to embody the general statistical relationship between the indicator related data of the passengers/drivers and the associated risk of incidents. The supervised learning model may define weights associated with specific indicators reflecting their relative importance to the risk scores or risk score estimates.

After computing or retrieving the passenger and driver risk scores, an overall pre-ride risk score is computed for each prospective combination of passenger and driver. The pre-ride risk score takes into account one or more ride conditions. The ride conditions include: ride time of day, ride origin, or ride destination, or ride duration. The pre-ride risk score may be inflated or deflated depending on the ride conditions. The pre-ride risk score subsequently serves as a benchmark for designation of drivers to passengers at step 230. Passenger driver combinations with a pre-ride risk score above a threshold value may represent a risk that is avoided by removing such drivers from the pool of available drivers.

As an example, the pre-ride risk score may account for differences in the gender of the passenger and the driver. The combination of a lady passenger with a male driver may be assigned a greater pre-ride risk score. Similarly the combination of a male passenger and a female driver may be assigned a greater risk score. Requests for ride at certain time of the day, such as late in the night may be assigned a higher or inflated pre-ride risk score.

The thresholds are determined based on historical incidents. A retrospective analysis of historical incident data and historical data of drivers and passengers allows the determination of the threshold which serves the purpose of mitigating future risk. The system 100 limits the pool of candidate drivers to drivers with associated pre-ride risk scores below a threshold to manage any incident related risks even before the ride begins.

In some embodiments the pre-ride risk score may be calculated as:

$$pre - ride risk score = \frac{Sum ( \begin{matrix}max ( passenger risk score , driver risk score ) + late night score + \\ different gender score + change in payment method score\end{matrix} )}{pre - ride score upper limit} * 10$$

The late night score is a value attributable to requests for rides later in the night. The late night score value may vary depending on the time of the day. For example, ride requests at 12 midnight may be assigned a higher value than ride requests at 8 μm. The different gender score indicates a difference in the gender of the driver and the passenger. The change in payment method is a score indicative of a recent change in payment method by the driver or the passenger. The determination of the pre-ride risk score may be performed independently of the determination of in transit risk-scores. Some embodiments may be directed to the execution of steps 220 and 230 independently of the steps 240 and 250 of the method of FIG. 2.

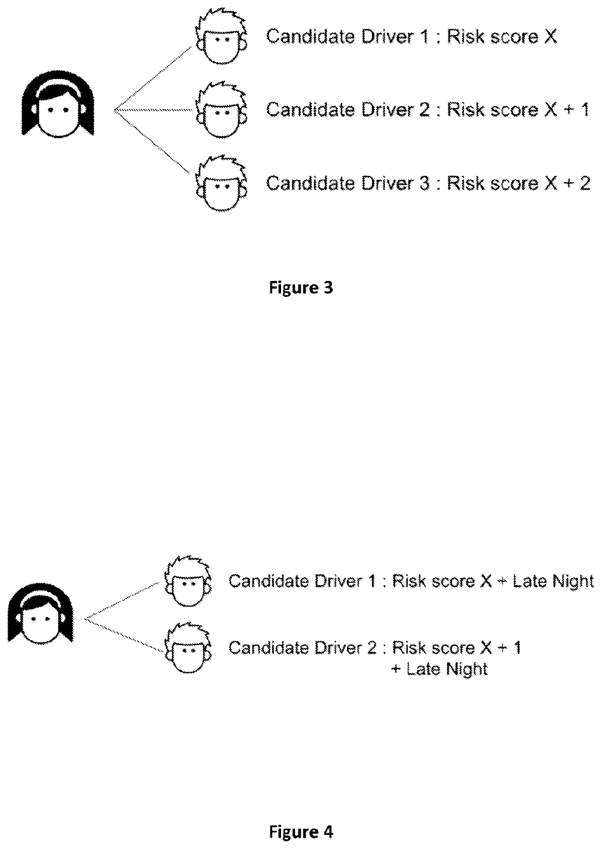

FIG. 3 illustrates an exemplary scenario wherein a lady passenger books a ride during day time. She has 3 candidate drivers ranging from risk score of X to X+2, wherein her pre-ride risk score with each of the candidate drivers is within (i.e. below) an acceptable risk threshold. FIG. 4 illustrates another exemplary scenario in which the same lady passenger from scenario 1 books a ride late at night. In the scenario of FIG. 4, she now has 2 candidate drivers since the candidate driver with risk score of X+2 in FIG. 3 is now above the predefined threshold when taking into account inflation of the pre-ride risk score due to a late night request for a ride. With the inflated pre-ride risk score, the same passenger has a smaller number of candidate drivers. This reduced set of candidate drivers helps mitigate potential risks associated with the ride conditions. At step 230, a driver is designated to the passenger. The driver is designated from a set of candidate drivers with a pre-ride risk score below a first predefined threshold. This selective allocation of drivers helps mitigate risks associated with incidents even before a ride commences.

Steps 240, 250 and 260 relate to management of in-transit risk after the ride begins—the ride phase. After the ride begins, the passenger's and the driver's respective computing devices intermittently transmit signals that are received by the system 100 at step 240. The transmitted signals include location information. On the commencement of a ride, the origin and destination information is known. Based on the origin and destination information, an expected ride plan is also available to the system 100. The ride plan may include an expected route or path between the origin and destination. The ride plan may also include an expected duration of the ride.

At step 250, the system 100 evaluates an in-transit risk score based on the signals received at step 240. The evaluation is done by assessing the conformity of the received signals with the expected ride plan. Conformity may be assessed by checking if the location information received from the driver/passenger's device is consistent with an acceptable path between the origin and destination. An unexpected stop or a prolonged stop as indicated by static location information from the signals may also be assessed as a non-conformity to the expected ride plan. The in-transit risk score is evaluated dynamically/iteratively as signals are received at step 240. As a ride progresses, the in-transit risk score may increase as non-conformity with the ride plan is detected. Other indicators of non-conformity include an unusual termination of the ride mid-way through the planned route or an overshooting of the estimated time of arrival (ETA).

Non-conformity with the expected ride plan may be numerically represented based on the degree of variation with the expected ride plan. For example, if a minor deviation—e.g. slight route variation that indicates the destination remains unchanged—from the expected route is detected, then the in-transit risk score may be increased by a small value. However, if a significant deviation is detected—e.g. a major route deviation that indicates the driver is no longer headed to the original destination—then the in-transit risk score may increase by a greater degree. The risk score may also increase if the passenger or driver changes the destination on their respective computing device during the ride phase.

In addition, the in-transit risk scores may be sensitive to the specific location of the vehicle. For example, a variation in the route in an urban area may lead to a smaller increase in the score when compared with a variation in the route in a more remote area. Thus the in-transit risk score may be a function of the absolute location information and risk information associated with the location. Certain more risk prone areas such as areas with more hazardous driving conditions or more crime prone areas may be allocated a greater in-transit risk score. Minor non-conformity of rides in such risk prone areas may nevertheless be flagged as a significant risk by increases in the in-transit risk score allowing more effective mitigation of risks or a more proactive response to potential incidents.

If the evaluated in-transit risk score at step 250 exceeds a predefined second threshold, then at step 260 a potential ride incident alert is triggered. The ride incident alert may be transmitted to a quick response team to further evaluate the ride status and check on the passenger and/or driver. Alternatively, a proactive notification or alert may be sent to the driver and/or passenger's computing device requesting information regarding their wellbeing or asking whether they need any assistance due to a potential incident. Alternatively, a proactive phone call may be made to the passenger and/or driver to assess their wellbeing and evaluate whether an incident has occurred. The responses to the proactive notification may also be used to further improve the accuracy of the entire method 200 by adjusting the evaluation of the risk score or the values of the first and second thresholds. The determination of the in-transit risk score may be performed independently of the determination of pre-ride risk-scores. Some embodiments may be directed to the execution of steps 240 and 250 independently of the steps 220 and 230 of the method of FIG. 4.

The combination of the use of pre-ride score and in-transit scores calculated by some embodiments enables the mitigation of risks before they occur and supports a proactive response to incidents that may eventually occur.

Some embodiments are directed to calculation of pre-ride risk scores by determining a passenger risk score based on passenger's records in the database; determining a driver risk score for each driver in a set of candidate drivers for the ride based on each driver's records in the database; and determining a pre-ride risk score for the ride for each driver in a set of drivers based on the driver risk score for the respective driver, the passenger risk score and one or more ride request conditions. A driver may then be designated—i.e. allocated to give the rider to the passenger—where the driver has a pre-ride risk score below a predefined threshold. This designation may be to the driver, of all drivers with a pre-ride risk score below the predefined threshold, who is closest to the origin at which the passenger will be picked up.

Some embodiments are directed to calculation of an in-transit risk score by periodically receiving signals from the passenger's computing device or the designated driver's computing device on commencement of a ride and evaluating an in-transit risk score associated with the ride based on conformity of the received signals with an expected ride plan. On the in-transit risk score exceeding a second predefined threshold, a ride incident event may be triggered. Moreover, the in-ride risk score may be used to update the risk score for one or both of the passenger and driver, or may be used to update one or both scores in the event that a ride incident is triggered. In addition, a passenger or driver risk score may be reduced if the passenger or driver experiences a predetermined period (e.g. 3 months) of low (e.g. fewer than 5) or no ride incidents.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Although this disclosure describes or illustrates particular embodiments as providing particular advantages, particular embodiments may provide none, some, or all of these advantages.

What is claimed is:

1. A system for ridesharing risk management, the system comprising:
one or more processors (processor(s));
a memory accessible to the processor(s);
a database comprising a plurality of passenger and driver records accessible to the processor(s);
the memory comprising program code executable by the processor(s) to:
receive a request for a ride from a passenger's computing device; determine a passenger risk score based on passenger's records in the database;
determine a driver risk score for each driver in a set of candidate drivers for the ride based on each driver's records in the database;
determine a pre-ride risk score for the ride for each driver based on the driver risk score for the respective driver, the passenger risk score and one or more ride request conditions;
designate a driver from the set of candidate drivers with a pre-ride risk score below a first predefined threshold;
periodically receive signals from the passenger's computing device or the designated driver's computing device on commencement of a ride;
evaluate an in-transit risk score associated with the ride based on conformity of the received signals with an expected ride plan; and
on the in-transit risk score exceeding a second predefined threshold, trigger a ride incident event.

2. The system of claim 1, wherein the received signals comprise real-time or near real-time location information, and
determination of conformity of the received signals with an expected ride plan is based on one or both of:
a stop-duration during the ride, and
conformity of the location information with a ride path between an origin and destination.

3. The system of claim 1, where the ride request conditions include one or more of: ride time of day, ride origin, or ride destination, or ride duration.

4. The system of claim 1, wherein the passenger risk score is determined based on a plurality of risk indicators generated based on the passenger's records, optionally wherein the risk indicators comprise one or more of:
passenger biographical record accuracy indicator,
passenger biographical record freshness indicator,
passenger interaction review indicator, and
passenger incident indicator.

5. The system of claim 1, wherein the driver risk score is determined based on a plurality of risk indicators generated based on the driver's records, optionally wherein the risk indicators comprise one or more of:
driver biographical record accuracy indicator,
driver biographical record freshness indicator,
driver interaction review indicator, and
driver incident indicator.

6. The system of claim 4, wherein each indicator is assigned a relative weight and the pre-ride risk score is determined based on the indicators and the relative weights.

7. The system of claim 1, wherein triggering the potential ride incident event comprises transmitting a notification to the passenger's computing device or the designated driver's computing device requesting a wellbeing status update.

8. A system for ridesharing risk management, the system comprising:
one or more processors (processor(s));
a memory accessible to the processor(s);
a database comprising a plurality of passenger and driver records accessible to the processors(s);
the memory comprising program code executable by the processor(s) to:
receive a request for a ride from a passenger's computing device; determine a pre-ride risk score for the ride for each driver based on the plurality of passenger and driver records, and one or more ride request conditions;
designate a driver from the set of candidate drivers with a pre-ride risk score below a first predefined threshold;
periodically receive signals from the computing device of the passenger or the designated driver on commencement of the ride;
evaluate an in-transit risk score associated with ride based on conformity of the received signals with an expected ride plan.

9. A computer-implemented method for ridesharing risk management, the method comprising:
receiving a request for a ride from a passenger's computing device; determining a passenger risk score based on passenger's records in a database;
determine a driver risk score for each driver in a set of candidate drivers for the ride based on each driver's records in the database;
determining a pre-ride risk score the ride for each driver based on the driver risk score, the passenger risk score and one or more ride request conditions;
designating a driver from the set of candidate drivers with a pre-ride risk score below a first predefined threshold;
periodically receiving signals from the computing device of the passenger or the designated driver on commencement of the ride;
evaluating an in-transit risk score associated with ride based on conformity of the received signals with an expected ride plan;
on the in-transit risk score exceeding a second predefined threshold, triggering a potential ride incident event.

10. The method of claim 9, wherein the received signals comprise real-time or near real-time location information, and
determining conformity of the received signals with an expected ride plan is based on one or more of:
a stop-duration during the ride,
a conformity of the location information with a ride path between an origin and destination.

11. The method of claim 9, where the ride request conditions include one or more of: ride time of day, ride origin, or ride destination, or ride duration.

12. The method of claim 9, wherein the passenger risk score is determined based on a plurality of risk indicators generated based on the passenger's records, optionally wherein the risk indicators comprise one or more of:
passenger biographical record accuracy indicator,
passenger biographical record freshness indicator,
passenger interaction review indicator,
passenger incident indicator.

13. The method of claim 9, wherein the driver risk score is determined based on a plurality of risk indicators generated based on the driver's records, optionally wherein the risk indicators comprise one or more of:
driver biographical record accuracy indicator,
driver biographical record freshness indicator,
driver interaction review indicator,
driver incident indicator.

14. The method of claim 12, wherein each indicator is assigned a relative weight and the pre-ride risk score is determined based on the indicators and the relative weight values.

15. The method of claim 9, wherein triggering the potential ride incident event comprises transmitting a notification to the passenger's computing device or the designated driver's computing device requesting a wellbeing status update.

16. A computer-implemented method for ridesharing risk management, the method comprising:
receiving a request for a ride from a passenger's computing device; determining a pre-ride risk score the ride for each driver in a set of candidate drivers, based on a plurality of passenger and driver records, and one or more ride request conditions;
designating a driver from the set of candidate drivers with a pre-ride risk score below a first predefined threshold;
periodically receiving signals from the computing device of the passenger or the designated driver on commencement of the ride;
evaluating an in-transit risk score associated with ride based on conformity of the received signals with an expected ride plan.

17. One or more non-transitory computer-readable storage media storing instructions that when executed by one or more processors cause the one or more processors to perform the method of claim 9.
